(19) United States
(12) Patent Application Publication
(10) Pub. No.: US 2023/0029596 A1
(43) Pub. Date: Feb. 2, 2023

(54) SURVEY DEVICE, SYSTEM AND METHOD

(71) Applicant: CLEAREDGE3D, INC., Superior, CO (US)

(72) Inventors: George Kelly CONE, Jonestown, TX (US); James Matthew NORRIS, Mableton, GA (US); Kevin Scott WILLIAMS, Glen Haven, CO (US); Michael BURENKOV, Natick, MA (US); John Howard SLOAN, IV, Broomfield, CO (US)

(21) Appl. No.: 17/390,402

(22) Filed: Jul. 30, 2021

(51) Int. Cl. G01C 15/06; G01C 15/00; G01C 21/16; G01S 17/89; G01S 17/06

(52) U.S. Cl. CPC G01C 15/06; G01C 15/002; G01C 21/1652; G01S 17/89; G01S 17/06

(57) ABSTRACT

A system includes a survey device and at least one processor. The survey device includes a support and a sensor attached to the support. The sensor is configured to capture measurement data. The at least one processor is coupled to the sensor to receive the measurement data. The at least one processor is configured to obtain a scene model corresponding to an initial set of the measurement data captured by the sensor when the support is located at an initial position, determine a location of the survey device relative to the scene model based on the initial set of the measurement data and the scene model, and update the location of the survey device relative to the scene model, based on subsequent sets of the measurement data captured by the sensor when the support is located at corresponding subsequent positions.

### BACKGROUND

High-end building construction projects require very precise measurements to ensure proper construction. Some components often have installation tolerances under a quarter, an eighth, or even a sixteenth of an inch, and if these tolerances are not met, there may be undesirable consequences.

Various methods exist for measuring or surveying on a construction jobsite. A simple tape measure is the most common tool employed, and along with a square and level, it is possible to provide reasonably accurate measurements. However, mistakes are common when using a tape measure, particularly when measuring points in two or three dimensions, where it is necessary to ensure orthogonality in each dimension. Additionally, longer measurements with a tape measure are more error prone as a small angular offset from orthogonality may translate into a large error on the other end. Finally, measurement errors from a tape measure compound on each other as measurements are made farther and farther away from a control point. For these reasons, tape measures may not be relied on for high-accuracy and/or multi-dimensional measurement control required for increasingly demanding construction applications.

Total stations and robotic total stations are more sophisticated instruments for accurately measuring points in two or three dimensions. These instruments represent a current gold standard for accurately measuring points in three dimensions on large construction jobsites. A total station requires two people to operate, i.e., one to set up, level, and operate the tripod-mounted total station, and another person to move a survey rod around to the various points to be measured. A robotic total station may be remotely controlled by the person with the survey rod, turning this into a one-man operation. Both total stations and robotic total stations are capable of achieving the high levels of measurement accuracy required on demanding construction projects. However, the inventors have noted a number of drawbacks.

Total stations are expensive and robotic total stations are even more expensive. Localization and operation of a total station requires a trained surveyor with extensive educational background and knowledge of trigonometry. In addition, the use of a survey rod requires a lot of practice to make sure it is perfectly vertical when taking a measurement. In addition to the difficulty of maintaining verticality, this requirement means that measurements may only be made on the floor or ground; not on a vertical surface like a wall or a ceiling. Further, a line of sight is required between the total station and the survey rod, and clear lines of sight are often unavailable on construction sites piled high with pallets and equipment. Last but not least, expensive robotic total stations require localization and are susceptible to being knocked off their tripods by ongoing construction activity.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic block diagram of a computer system, in accordance with some embodiments.

FIG. 1B is a schematic view of a survey device in accordance with some embodiments, and FIG. 1C is a diagram schematically showing the survey device in an operation in accordance with some embodiments.

FIG. 2 is a flowchart of a method of operating a survey device, in accordance with some embodiments.

FIG. 3 is a diagram schematically showing a survey device in an operation, in accordance with some embodiments.

FIGS. 4 and 5 are diagrams schematically showing various operations of a survey device, in accordance with some embodiments.

### DETAILED DESCRIPTION

The following disclosure provides many different embodiments, or examples, for implementing different features of the provided subject matter. Specific examples of components, materials, values, steps, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

One or more embodiments provide a method, a system, and/or a survey device for measuring points and coordinates on a construction jobsite. Various features associated with some embodiments will now be set forth. Prior to such description, a glossary of terms applicable for at least some embodiments is provided.

Scene: According to some embodiments, a Scene (also referred to herein as “scene”) includes or refers to the set of physical, visible objects in the area where a survey device (also referred to in some embodiments as “measuring tool”) is to be used, along with each object's location. For instance, the Scene inside a library would include the walls, windows, bookshelves, books, and desks, i.e., physical objects that are visible within that library.

Virtual Model: According to some embodiments, a Virtual Model (also referred to herein as “virtual model”) is a digital representation of one or more physical objects that describes the geometry of those objects. In some embodiments, a Virtual Model is a 2D drawing. In some embodiments, a Virtual Model is a collection of one or more faces that describe the boundary or a portion of the boundary of a set of one or more objects. For example, a Virtual Model that contains the top and bottom faces of a cube would be a Virtual Model that describes a portion of the boundary of the cube. Similarly, a Virtual Model that contains all six faces of a cube would be a 3D model that describes the entire boundary of the cube. In at least one embodiment, a Virtual Model may comprise Computer Assisted Design (CAD) objects. In one or more embodiments, a Virtual Model may comprise Constructive Solid Geometry (CSG) objects. A Virtual Model may also comprise a triangular mesh used to represent all, or a portion of, one or more objects. A Virtual Model may also comprise points that fall on the surface of the object, such as a point cloud from a sensor, such as a laser scanner or the like. A Virtual Model may also be a digital volumetric representation of one or more physical objects, such as an occupancy grid map. A digital representation of geometry may comprise the Virtual Model.

Scene Model: According to some embodiments, a Scene Model (also referred to herein as “scene model”) is a Virtual Model that describes the geometry of a Scene. In at least one embodiment, the Scene Model accurately reflects the shape and physical dimensions of the Scene and accurately reflects the positions of objects visible in that scene.

Localization (or Localizing): According to some embodiments, Localization (also referred to herein as “localization”) of an instrument refers to the process of determining the 2D or 3D location of that instrument according to a working coordinate system used by the Scene Model. In some embodiments, the instrument to be localized is a survey device as described herein. The working coordinate system may be any coordinate system usable to describe objects in the scene model. In at least one embodiment, the working coordinate system is different from a pre-defined coordinate system in which the scene model is expressed when the scene model is generated and/or loaded. For example, the pre-defined coordinate system is a Cartesian coordinate system, whereas the working coordinate system is a spherical coordinate system or a Cartesian coordinate system having the origin shifted from the origin of the pre-defined Cartesian coordinate system. In at least one embodiment, more than one working coordinate system may be used. In at least one embodiment, the working coordinate system is the same as the pre-defined coordinate system.

Measurement Data: According to some embodiments, Measurement Data (also referred to herein as “measurement data”) refers to any data describing the relative spatial arrangement of objects, and may include photography, laser scan data, survey data, or any other spatial measurements. In one or more embodiments, Measurement Data may include measurement data of color patterns on a surface (e.g., for photogrammetry). In at least one embodiment, Measurement Data may also refer to the identification of one or more locations.

Point Cloud: According to some embodiments, a point cloud is a collection of measured points (also referred to as locations) of a scene. These measured points may be acquired using a laser scanner, photogrammetry, or other similar 3D measurement techniques. In some embodiments, measurement data include measured points.

Element: According to some embodiments, an Element (also referred to herein as “element”) is a physical object that is installed or constructed during construction. Examples of elements include, but are not limited to, an I-beam, a pipe, a wall, a duct, or the like.

Self-Locating Device: According to some embodiments, a Self-Locating Device (also referred to herein as “self-locating device” or “self-locating measuring tool”) is a tool or instrument configured to capture Measurement Data and use this data to Localize itself to a working coordinate system of the Scene Model. In some embodiments, the Self-Locating Device may be used to measure or record locations after it has been Localized. In some embodiments, the Self-Locating Device may be used to Lay Out after it has been Localized. This list of embodiments is not exclusive; other types of Self-Locating Devices are possible in further embodiments. In at least one embodiment, a survey device described herein is a Self-Locating Device.

Design Model: According to some embodiments, a Design Model (also referred to herein as “design model”) is a Virtual Model that describes the geometry of a physical structure or object to be constructed or installed. For example, a Design Model of a simple square room may include digital representations of four walls, a floor, and a ceiling—all to scale and accurately depicting the designer's intent for how the building is to be constructed. According to some embodiments, the Design Model exists in the same working coordinate system as the Scene Model.

Design Location: According to some embodiments, the Design Location (also referred to herein as “design location”) is the spatial location where the Element is intended to be installed.

Laying Out or Layout: According to some embodiments, Laying Out (also referred to herein as “laying out”) is the process of locating a pre-defined coordinate on a construction jobsite and marking it. For example, a Design Model may call for a hole to be drilled into the floor at a point 10 feet West and 22 feet North of the corner of the building (i.e., the Design Location). If a surveyor (or user) Lays Out this point, it means the surveyor performs the measurements in the building to accurately find this point (i.e., the Design Location), and then he places a mark on the floor at this precise location so a construction worker may drill out a hole later.

Indicator: According to some embodiments, an Indicator (also referred to herein as “indicator”) describes the part of the measurement tool that allows a user to physically touch or point to one or more locations in the Scene. In some embodiments, an Indicator is a physical tip of the measuring tool that a user may move to point to a specific, measured position. For example, an Indicator may be a tip of a survey rod, which a surveyor may touch to a corner of a beam in order to measure the position of that corner.

Data Interface: According to some embodiments, a Data Interface (also referred to herein as “data interface”) includes a portion of a computer system that allows data to be loaded onto and/or from a computer system. In some embodiments a network interface operates as a data interface, allowing data to be loaded across a wired or wireless network. In some embodiments, an input/output interface or device operates as a data interface. In some embodiments, a removable memory device or removable memory media operates as a data interface, allowing data to be loaded by attaching the device or by loading the media. In some embodiments, data are pre-loaded into a storage device, e.g., a hard disk, in the computer system, and the storage device operates as a data interface. This list of example embodiments is not exclusive; other forms of a data interface appear in further embodiments.

In some embodiments, a survey device comprises a sensor configured to capture measurement data of a scene where the survey device is located. At least one processor is coupled to the sensor to receive the measurement data. The at least one processor is an internal processor of the survey device, or an external processor. The at least one processor is configured to obtain a scene model corresponding to an initial set of the measurement data captured by the sensor when a support of the survey device is located at an initial position at the scene. In some embodiments, when no existing scene model is available, the at least one processor is configured to generate a scene model based on the initial set of the measurement data. In one or more embodiments, the at least one processor is configured to match the initial set of the measurement data to an existing scene model. After matching or generating the scene model, the at least one processor is configured to determine a location (and, in some embodiments, an orientation, e.g., which direction the survey device is facing) of the survey device relative to the scene model, when the survey device is at the initial position as well as when the survey device is at one or more subsequent positions at the scene. In some embodiments, determining a location of the survey device relative to the scene model means that the survey device and the scene model are in a common working coordinate system which can be any working coordinate system, e.g., a working coordinate system of the scene model, a working coordinate system of the survey device, or another working coordinate system. In an example, the survey device is localized in a working coordinate system of the scene model, and will use this working coordinate system of the scene model as a base map against which to locate itself when the survey device is moved around the scene for surveying, measuring or laying out. In another example, the scene model is localized in a working coordinate system of the survey device. A person of ordinary skill in the art would understand that these two scenarios are mathematically equivalent, with the transform to localize the scene model in the working coordinate system of the survey device simply being the inverse of the transform to localize the survey device in the working coordinate system of the scene model. This is different from other approaches where a device locates itself against a previous frame of data captured by a sensor. In the other approaches, as the device is moving around, positioning errors are accumulated from one frame to the next, potentially resulting in an unacceptable inaccuracy. In contrast, in one or more embodiments, the location and orientation of the survey device are always determined using the same scene model. As result, in at least one embodiment, high levels of measurement accuracy are obtainable which is especially suitable for demanding construction projects.

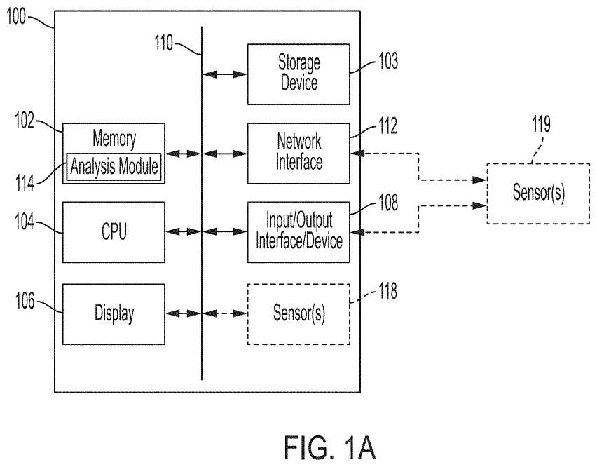

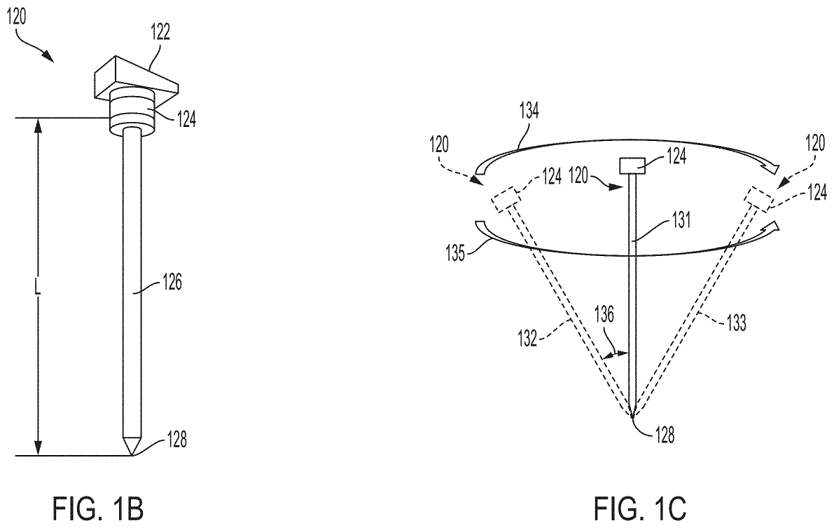

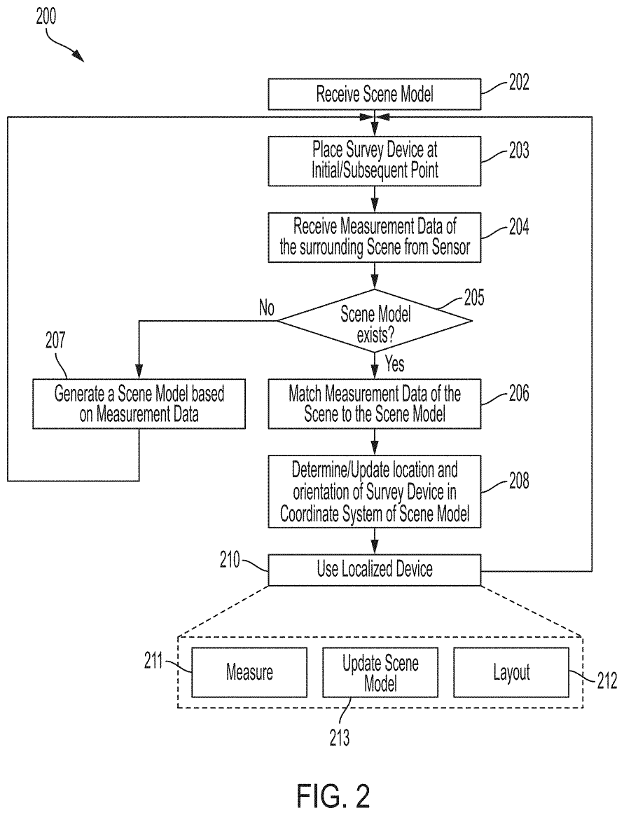

FIG. 1A is a schematic block diagram of a computer system 100 configured in accordance with some embodiments. In one or more embodiments, the computer system 100 is partly or wholly included in a survey device as described herein. In at least one embodiment, the computer system 100 is completely external to the survey device, and is coupled to the survey device by a wired or wireless connection. In some embodiments, the computer system 100 is configured to perform, e.g., by executing a set of instructions stored in a memory, one or more of the methods, processes or operations described herein, e.g., the methods and/or operations described in connection with one or more of FIGS. 2-4. In some embodiments, the computer system 100 includes components suitable for use in 3D modeling.

In some embodiments, the computer system 100 includes one or more of various components, such as a memory 102, a storage device 103, a hardware central processing unit (CPU) or processor or controller 104, a display 106, one or more input/output interfaces or devices 108, and/or a network interface 112 coupled with each other by a bus 110. In some embodiments, the CPU 104 processes information and/or instructions, e.g., stored in memory 102 and/or storage device 103. In some embodiments, the CPU 104 comprises one or more individual processing units. In one or more embodiments, CPU 104 is a distributed processing system, an application specific integrated circuit (ASIC), and/or a suitable processing unit. In one or more embodiments, a portion or all of described processes and/or methods and/or operations, is implemented in two or more computer systems 100 and/or by two or more processors or CPUs 104.

In some embodiments, the bus 110 or another similar communication mechanism transfers information between the components of the computer system, such as memory 102, CPU 104, display 106, input/output interfaces or devices 108, and/or network interface 112. In some embodiments, information is transferred between some of the components of the computer system 100 or within components of the computer system 100 via a communications network, such as a wired or wireless communication path established with the internet, for example.

In some embodiments, the memory 102 and/or storage device 103 includes a non-transitory, computer readable, storage medium. In some embodiments, the memory 102 and/or storage device 103 includes a volatile and/or a non-volatile computer readable storage medium. Examples of the memory 102 and/or storage device 103 include, but are not limited to, electronic, magnetic, optical, electromagnetic, infrared, and/or a semiconductor system (or apparatus or device), such as a semiconductor or solid-state memory, a magnetic tape, a removable computer diskette, a random access memory (RAM), a read-only memory (ROM), a rigid magnetic disk (hard disk driver or HDD), a solid-state drive (SSD), and/or an optical disk. In some embodiments, memory 102 stores a set of instructions to be executed by the CPU 104. In some embodiments, memory 102 is also used for storing temporary variables or other intermediate information during execution of instructions to be executed by the CPU 104. In some embodiments, the instructions for causing CPU 104 and/or computer system 100 to perform one or more of the described steps, operations, methods, and/or tasks may be located in memory 102. In some embodiments, these instructions may alternatively be loaded from a disk (e.g., the storage device 103) and/or retrieved from a remote networked location. In some embodiments, the instructions reside on a server, and are accessible and/or downloadable from the server via a data connection with the data interface. In some embodiments, the data connection may include a wired or wireless communication path established with the Internet, for example.

In some embodiments, the network interface 112 comprises circuitry included in the computer system 100, and provides connectivity to a network (not shown), thereby allowing the computer system 100 to operate in a networked environment. In some embodiments, computer system 100 is configured to receive data such as measurements that describe portions of a scene from a sensor through the network interface NIC 112 and/or the input/output interfaces or devices 108. In some embodiments, network interface 112 includes one or more wireless network interfaces such as BLUETOOTH, WIFI, WIMAX, GPRS, LTE, 5G, or WCDMA; and/or one or more wired network interfaces such as ETHERNET, USB, or IEEE-1364.

In some embodiments, the memory 102 includes one or more executable modules to implement operations described herein. In some embodiments, the memory 102 includes an analysis module 114. In some embodiments, the analysis module 114 includes software for analyzing a set of point cloud data, an example of such software includes Verity™ which is developed by ClearEdge 3D, Broomfield, Col. In some embodiments, the analysis module 114 also includes executable instructions for causing the CPU 104 to perform one or more operations, methods, and/or tasks described herein, such as matching measurement data to a scene model, computing a required transform, and applying that transform to the location of the survey device to localize the survey device relative to the scene model. Examples of operations performed by such an analysis module 114 are discussed in greater detail below, e.g., in connection with one or more of FIGS. 2-4. It should be noted that the analysis module 114 is provided by way of example. In some embodiments, additional modules, such as an operating system or graphical user interface module are also included. It should be appreciated that the functions of the modules may be combined. In addition, the functions of the modules need not be performed on a single survey device. Instead, the functions may be distributed across a network, if desired. Indeed, some embodiments of the invention are implemented in a client-server environment with various components being implemented at the client-side and/or server-side.

In some embodiments, the computer system 100 further comprises a display 106, such as a liquid crystal display (LCD), cathode ray tube (CRT), a touch screen, or other display technology, for displaying information to a user. In some embodiments, a display 106 is not included as a part of computer system 100. In some embodiments, the computer system 100 is configured to be removably connected with a display 106.

In some embodiments, the memory 102 and/or storage device 103 comprises a static and/or a dynamic memory storage device such as a flash drive, SSD, memory card, hard drive, optical and/or magnetic drive, and similar storage devices for storing information and/or instructions. In some embodiments, a static and/or dynamic memory 102 and/or storage device 103 storing media is configured to be removably connected with the computer system 100. In some embodiments, data such as measurements that describe portions of a scene are received by loading a removable medium (such as storage device 103) onto memory 102, for example by placing an optical disk into an optical drive, a magnetic tape into a magnetic drive, or similar data transfer operations. In some embodiments, data such as measurements that describe portions of a scene are received by attaching a removable static and/or dynamic memory 102 and/or storage device 103, such as a flash drive, SSD, memory card, hard drive, optical, and/or magnetic drive, or the like, to the computer system 100. In some embodiments, data such as measurements that describe portions of a scene are received through network interface 112 or input/output interfaces or devices 108. Examples of input/output interfaces or devices 108 include, but are not limited to, a keyboard, keypad, mouse, trackball, trackpad, touchscreen, and/or cursor direction keys for communicating information and commands to CPU 104.

In some embodiments, the computer system 100 further comprises one or more sensors 118 coupled to the other components of the computer system 100 by the bus 110. In one or more embodiments, the computer system 100 is couplable, e.g., through network interface 112 and/or input/output interfaces or devices 108, with external sensors 119. One or more of the sensors 118, 119 correspond to one or more sensors of a survey device as described herein. Examples of sensors 118, 119 include, but are not limited to, a laser scanner, a Light Detection and Ranging (LIDAR) scanner, a depth sensor, a video camera, a still image camera, an echolocation sensor (e.g., a sonar device) a Global Positioning System (GPS) receiver, an Inertial Measurement Unit (IMU), a compass, an altimeter, a gyroscope, an accelerometer, or the like.

FIG. 1B is a schematic view of a survey device 120 in accordance with some embodiments. In some embodiments, survey device 120 is a Self-Locating Device configured to be used to both measure and Lay Out. In the example configuration in FIG. 1B, survey device 120 comprises a device 122, a sensor 124, a support 126, and an indicator 128.

Device 122 is a piece of hardware supported by support 126, and configured to either perform one or more required computations as described herein, or connect to an external device (through wires or wirelessly) that performs the required computations. In at least one embodiment, device 122 comprises a processor corresponding to CPU 104 to perform one or more of the required computations. In one or more embodiments, device 122 comprises a data interface as described with respect to FIG. 1A, to connect to and transfer data to/from an external processor or an external computer system (e.g., a laptop, smartphone, tablet, or the like) that performs the required computations. In at least one embodiment, device 122 comprises one or more components of computer system 100. For example, in some embodiments, device 122 includes a display, such as display 106 described with respect to FIG. 1A, for reporting measurements and indicating results to a user. In some embodiments, device 122 is configured to transmit measurement reports and results to an external display.

In some embodiments, device 122 is a portable device that is removably attached to support 126 by any suitable structures, such as, threads, bayonet mechanisms, clips, holders (such as phone or tablet holders), magnets, hook-and-loop fasteners, or the like. In at least one embodiment, the portable device has a computer architecture corresponding to computer system 100. Examples of such portable device include, but are not limited to, smart phones, tablets, laptops, or the like. In some embodiments, the portable device comprises sensor 124. For example, the portable device is a tablet or smartphone equipped with a sensor, e.g., a LIDAR scanner, configured to capture spatial measurement data. The illustrated arrangement of device 122 on top of sensor 124 and/or at an upper end of support 126 is an example. Other configurations are within the scopes of various embodiments.

Sensor 124 is configured to capture measurement data of a surrounding Scene to be used in localizing survey device 120 and/or in using survey device 120 for measuring or laying out. In at least one embodiment, sensor 124 comprises more than one sensor of the same type or different types. In some embodiments, sensor 124 may include a laser scanning device configured to capture point measurements, such as a SICK LIDAR system, a Velodyne LIDAR system, a Hokuyo LIDAR system, or any of a number of flash LIDAR systems. A resulting “point cloud” of distance measurements collected from the laser scanning device may be matched to the 3D geometry of a Scene Model to determine the location and pose (or orientation) of survey device 120, as described with respect to FIG. 2.

In some embodiments, sensor 124 may include a depth sensor configured to use structured light, instead of a laser scanning device, to capture a point cloud of distance measurements.

In some embodiments, sensor 124 may include a camera system of one or more calibrated video cameras and/or still image cameras configured to capture images at high refresh rates. Resulting imagery data collected from this camera system may be matched to either a previous frame of imagery data, or to projected edges of the 3D geometry of the Scene Model to determine the location and pose of survey device 120, as described with respect to FIG. 2. In some embodiments, the frames from the cameras may be used, e.g., by a processor in device 122 and/or by an external processor to create a point cloud of distance measurements through the use of photogrammetric reconstruction. This point cloud may be matched to the 3D geometry of the Scene Model to determine the location and pose of survey device 120, as described with respect to FIG. 2.

In some embodiments, sensor 124 may include a Global Positioning System (GPS) receiver for receiving data from GPS satellites to help compute the position of survey device 120. In some embodiments, sensor 124 may include an Inertial Measurement Unit (IMU) to help compute the position and/or orientation of survey device 120. In some embodiments, sensor 124 may include a compass to help compute the orientation of survey device 120. In some embodiments, sensor 124 may include an altimeter to help compute the altitude of survey device 120. In some embodiments, sensor 124 may include one or more survey prisms to enable survey device 120 to be located by a total station. For example, the total station emits a light beam towards survey device 120, collect a light beam reflected off one or more survey prisms of survey device 120, and, based on the emitted and reflected light beams, calculate the location of survey device 120. The calculated location of survey device 120 is obtained from the total station, and is used to localize survey device 120 as described herein. In some embodiments, sensor 124 may contain a multitude of different sensors for computing the position and/or orientation of survey device 120.

Sensor 124 is attached to support 126. In some embodiments, sensor 124 is rigidly attached to support 126. Herein, “rigidly attached” comprises not only permanent attachment of sensor 124 to support 126, but also removable attachment of sensor 124 to support 126, provided that a relative position or a spatial relationship between support 126 and sensor 124 rigidly attached thereto remains unchanged by and during movements of survey device 120 around a scene to be surveyed or laid out. In other words, a spatial relationship between sensor 124 and indicator 128 is known or predetermined. Examples of suitable structures for removably but rigidly attaching sensor 124 to support 126 include, but are not limited to, threads, bayonet mechanisms, clips, holders, magnets, hook-and-loop fasteners, or the like. In some embodiments, sensor 124 is movably or adjustably attached to support 126, provided that a spatial relationship between sensor 124 and indicator 128 is determinable. In an example, support 126 may have first and second portions movably connected with each other by a pivot, the first portion having sensor 124, and the second portion having indicator 128. An angle between the first and second portions is adjustable because of the pivot, but this angle is determinable. In an example, a current is run through the arc between the first and second portions, and the resistance is measured to determine the angle. In a further example, each of the first and second portions of the support has a separate tilt angle sensor, and a difference between outputs of the two tilt angle sensor indicates the angle between the first and second portions of the support. The determinable angle and known dimensions of the first and second portions of the support make it possible to determine a spatial relationship between sensor 124 and indicator 128. The known or determinable spatial relationship between sensor 124 and indicator 128 is used to localize survey device 120 as described herein.

In some embodiments where sensor 124 comprises a plurality of sensors, some or all of such sensors are removably attached to each other by any suitable structures, such as, threads, bayonet mechanisms, clips, holders, magnets, hook-and-loop fasteners, or the like. For example, the sensors are sequentially and removably attached one on top another, and on an upper portion of support 126. In at least one embodiment, this arrangement provides survey device 120 with high customizability and permits a user to choose one or more suitable sensors to be used by survey device 120 for a particular survey job and/or a particular construction project. The illustrated arrangement of sensor 124 at an upper end of support 126 is an example. Other configurations are within the scopes of various embodiments.

In some embodiments, support 126 is an elongated support or a rod, as illustrated in FIG. 1B. In at least one embodiment, support 126 serves as a handle by which the user may hold survey device 120 and move to reposition survey device 120 within the scene. The illustrated and described configuration of support 126 as a rod is an example. Other configurations are within the scopes of various embodiments. For example, any shape or configuration of support 126 that allows a person to move survey device 120 will suffice in one or more embodiments.

Indicator 128 is used to position survey device 120 at a point to be measured or laid out. In some embodiments, the location of survey device 120 is the location of indicator 128. Because the spatial relationship between sensor 124 and indicator 128 is known or determinable, the location of indicator 128 is positively related to and is determinable from the location of the sensor 124, and vice versa. Therefore, the location of survey device 120 is also representable by the location of sensor 124, in one or more embodiments. A description herein that survey device 120 is placed at a point means indicator 128 is placed at that point. In the example configuration in FIG. 1B, indicator 128 is the tip at a lower end of support 126. Other indicator configurations are within the scopes of various embodiments. For example, in one or more embodiments, indicator 128 is a cross hair or any other physical indicator that may be placed accurately at a point which the user wishes to measure. The arrangement of indicator 128 at the lower end of support 126 is an example. Other parts of support 126 where indicator 128 may be arranged are within the scopes of various embodiments.

In some embodiments, indicator 128 has a predetermined or determinable spatial relationship with sensor 124. For example, a distance or length L between sensor 124 and indicator 128 is predetermined or known, and is input to at least one processor to enable the at least one processor to accurately determine the location of indicator 128 based on measurement data captured by sensor 124 arranged at the predetermined distance L away.

FIG. 1C is a diagram schematically showing the survey device 120 in an operation, in accordance with some embodiments.

In the operation in FIG. 1C, also referred to herein as a “swooshing” operation, sensor 124, e.g., a LIDAR scanner, is configured to capture measurement data when survey device 120 is moved, e.g., by a user, while keeping indicator 128 stationary. For example, survey device 120 is moved among a plurality of different postures 131, 132, 133 by movements schematically indicated by arrows 134, 135. The illustrated postures and movements are examples. Other postures and movements in a “swooshing” operation are within the scopes of various embodiments. As survey device 120 is moved, a tilt angle between each posture and vertical posture 131 is determined by a suitable sensor, e.g., a gyroscope. For example, angle 136 between posture 132 and vertical posture 131 is illustrated in FIG. 1C. This measured angle and the predetermined distance L between indicator 128 and sensor 124 permit the processor to correctly interpret and/or process measurement data captured by sensor 124 despite that sensor 124 is at different locations and/or elevations when measurement data are captured. In some embodiments, the tilt angle associated with a particular posture of survey device 120 is determined by comparing the measurement data associated with that posture with the scene model. As a result of the “swooshing” operation, it is possible to obtain a larger amount of measurement data than when survey device 120 stays still because, for example, of a limited field of view of the sensor 124. The larger amount of measurement data increases accuracy of measurements in one or more embodiments. This is an advantage over other approaches where a survey rod must be vertical when taking a measurement. In some embodiments, it is possible to place indicator 128 on any point to be measured, including, but not limited to, the ground, a floor, a wall, a ceiling, a duct or the like. This is another advantage over other approaches where it is difficult, if not impossible, to perform measurements on a wall or a ceiling with a tripod-mounted total station.

FIG. 2 is a flowchart of a method 200 of operating a survey device, in accordance with some embodiments. In one or more embodiments, the survey device used in the method 200 corresponds to one or more survey devices described with respect to FIGS. 1A-1C. The method 200 includes operations for locating or localizing the survey device within a Scene using Measurement Data (e.g., scanning or imaging Measurement Data), and then indicating locations in the physical space of the Scene in accordance with one or more embodiments. An exemplary set of operations 202-213 for performing this process is discussed in detail below. In some embodiments, some or all of the exemplary set of operations 202-213 correspond to computer-executable instructions stored in memory 102 and/or storage device 103 for execution by CPU 104. In at least one embodiment, unless otherwise specified, the operations described with respect to FIG. 2 are performed by at least one processor, e.g., one or more CPUs 104.

At operation 202, a scene model is received by a processor or a computer system.

For example, the processor receives, through a data interface as described with respect to FIG. 1A, data describing a Scene Model. In some embodiments, a computer system receives, through a data interface, a data set describing a set of measurements of one or more elements in a scene. For example, in some embodiments a data file containing a set of one or more laser scans may be loaded onto a computer system 100 through a network interface 112 and stored in memory 102 and/or storage device 103 as illustrated in FIG. 1A. As another example, in some embodiments an optical storage disk or another removable medium containing photogrammetric measurements of a factory are placed in an optical disk drive or a corresponding reader. In some embodiments, a cloud of point measurements of a scene (which in some embodiments is called a “Point Cloud”) is loaded into the memory 102 of a computing device 100 for processing as illustrated in FIG. 1A. In some embodiments, the Scene Model may be a CAD design model, a Building Information Modeling (“BIM”) design, or a set of laser scan data collected previously showing the as-built conditions at the construction site (i.e., the Scene). In some embodiments, operation 202 is omitted, e.g., when an existing scene model is not available. In this situation, the processor is configured to generate a scene model from measurement data, as described with respect to operation 207.

At operation 203, the survey device is placed at an initial point. In an example, the survey device is brought to the scene to be surveyed, e.g., a construction jobsite. An indicator, e.g., indicator 128, of the survey device is placed on an initial point (or initial position). A point having a known location is referred to herein as “control point.” In at least one embodiment described herein, the initial point is a control point of a known location that was previously determined, e.g., by using survey equipment such as a total station, and marked at the scene. In one or more embodiments, when the indicator is placed at the initial point, a total station is used to determine the location of the initial point by interacting, via light beams, with one or more prisms rigidly attached to a support of the survey device, as described herein. The known location of the initial point is input to the processor or computer system for use in a subsequent operation for generating (operation 207) or mapping/matching (operation 206) a scene model. In at least one embodiment, the known location is the absolute location of the initial point relative to the Earth's surface. In some embodiments, operation 203 of placing the survey device at an initial point is performed before operation 202.

At operation 204, measurement data of the scene surrounding the survey device and captured by a sensor of the survey device are received by the processor or computer system.

For example, when the indicator is placed at the initial point, a sensor, e.g., sensor 124, of the survey device captures measurement data of the scene surrounding the survey device. In some embodiments, a “swooshing” operation is performed when the sensor captures measurement data. For example, the computer system prompts, e.g., by a notification on a display or by an audible notification, a user of the survey device to perform a “swooshing” operation. The measurement data captured by the sensor are transferred to the processor or computer system.

In some embodiments, the computer system receives direct measurements from the sensor, e.g., a scanning device such as a laser scanner or LIDAR scanner. In further embodiments, the computer system receives calibrated imagery from an imaging device such as a camera, which may be used to create measurements through the science of photogrammetry as will be understood by one of ordinary skill in the art. In further embodiments, the computer system receives both direct measurement data as well as imagery data. The computer system may be physically separate from the survey device or incorporated into the survey device. The computer system may also be implemented by being distributed across multiple components. The computer system may be implemented in a network cloud.

At operation 205, the processor determines whether a scene model exists. When a scene model corresponding to the scene exists (Yes at operation 205), the processor proceeds to operation 206. When a scene model corresponding to the scene does not exist (No at operation 205), the processor proceeds to operation 207.

At operation 206, the processor is configured to match (or map) the measurement data captured by the sensor to an existing scene model which was either received at operation 202 or generated at operation 207 as described herein. For example, the processor is configured to find or calculate a transform that maps the measurement data to the scene model. Examples of transforms include linear transforms and non-linear transforms. Examples of linear transforms include, but are not limited to, rotation, translation, shearing, scaling, or the like. A linear transform that includes only rotation and/or translation is referred to as a rigid body transform. An example of non-linear transform includes data correction applied to correct distortion in raw data captured by the sensor. For example, when the sensor is an imaging device such as a camera, captured images may be distorted due to a lens configuration of the camera, and a non-linear transform is applied to compensate for the image distortion. Other linear and non-linear transforms are within the scopes of various embodiments.

In an example matching operation, a linear transform required to match the measurement data of the scene to the scene model is computed. In some embodiments, the location and angular pose (e.g., orientation) of the survey device with respect to the Scene may initially be unknown. However, by finding the correspondence between the Measurement Data of the Scene and an accurate Scene Model, the position and angular pose may be determined. If the Measurement Data is reasonably accurate, and the Scene Model is a reasonably accurate representation of the Scene, then a linear transform (rotation, and/or translation, and/or scaling) is assumed to exist that may transform the Measurement Data to closely fit the geometry of the Scene Model. In some embodiments, this rotation/translation/scaling transform that matches the Measurement Data to the Scene is computed. In some embodiments, this rotation/translation/scaling transform is computed by first finding rough correspondences between distinct geometric features, obtaining an initial coarse alignment, and then refining this alignment using the Iterative Closest Point (ICP) algorithm, as will be understood by one of ordinary skill in the art.

In some embodiments, when the matching operation is performed based on the measurement data captured at the initial point having a known location, the scene model is also associated with the known location of the initial point. As a result, the scene model and a working coordinate system of the scene model are determined, and can be used for localizing the survey device at further points at the scene.

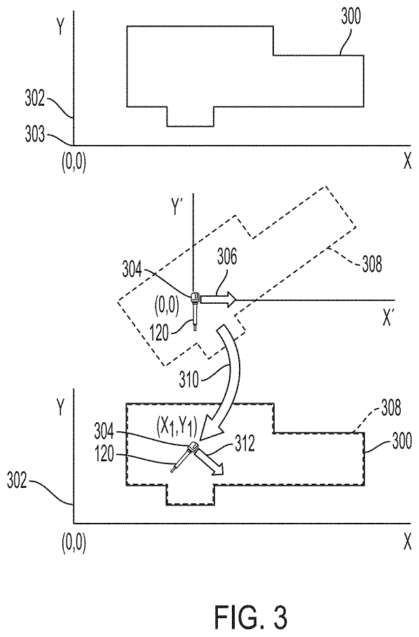

In some embodiments, a user may provide, through a user interface, a rough or estimated location (also referred to herein as “seed position”) of the survey device to help guide this matching process. In some embodiments, the initial rough location may be provided by the user selecting a location shown on a display, such as a touch screen. For instance, a Scene Model of a hotel may have many nearly identical rooms, each of which may match well against the Measurement Data from any other room. However, if a user provides the rough location (e.g., “room 221”), then the matching process may be made much more reliable. Further details of this matching process by computing a linear transform is described with respect to FIG. 3. Other matching techniques are within the scopes of various embodiments.

At operation 208, the processor is configured to determine a location of the survey device relative to the scene model. In at least one embodiment, an orientation of the survey device relative to the scene model is also determined. In some embodiments, the survey device is localized with respect to a working coordinate system of the scene model. The first time the survey device is localized when brought to a scene is referred to herein as “initial localization.” In some embodiments, the processor uses the transform computed in operation 206 to determine the survey device's current location, i.e., the location of the Indicator within the Scene. In at least one embodiment, the orientation of the survey device relative to the scene model is also determined by the transform computed in operation 206. Further details of an example of this localization process is described with respect to FIG. 3. Other localization techniques are within the scopes of various embodiments.

At operation 207, when an existing scene model is not available, a scene model is generated by the processor based on the captured measurement data. In at least one embodiment, operation 207 is omitted when a scene model of the scene exists, e.g., when the scene model was received as described with respect to operation 202, or when the scene model was generated by a previous execution of operation 207. After generating the scene model, the process returns to operation 203 where the survey device is moved to a subsequent or new point at the scene, and then the process proceeds through operations 204, 206, 208, 210 as described herein.

In some embodiments, the processor is configured to generate the scene model based on the measurement data captured by the sensor of the survey device at an initial point (e.g., by operation 207), and then update or build-up the scene model based on measurement data captured by the sensor of the survey device at one or more further points (e.g., by one or more iterations of operations 203, 204, 206, 208, 213). For example, after capturing the measurement data at the initial point of the known location, the survey device is moved, e.g., by the user, to a further point and the sensor captures measurement data describing the scene from the further point. The two sets of measurement data captured at the two points are merged together to build-up the scene model of the scene. When the described process is applied in the specific hotel example described herein, the survey device performs multiple scans in multiple corresponding rooms to generate and build-up a scene model for the hotel.

At operation 210, the survey device localized at operation 208 is used in one or more further operations. Example uses of the localized survey device include, but are not limited to, measurement, laying out, or the like. In the example in FIG. 2, operation 210 includes one or more of operation 211, operation 212, and operation 213.

At operation 211, the localized survey device is used to take measurements at the point where the indicator of the survey device is currently located. In some embodiments, the location, e.g., a 3D location, of the indicator computed in the working coordinate system of the scene model at operation 208 is outputted, reported and/or displayed to the user. In some embodiments the 3D coordinate of the indicator is displayed on a screen on the survey device itself. In further embodiments, the 3D coordinate is displayed on a device or computer system connected to the survey device by wires or wirelessly. In further embodiments, the 3D coordinate is stored and displayed for output at a later time.

At operation 212, the localized survey device is used to perform a layout task. In some embodiments when the survey device is being used to Lay Out, the survey device receives one or more Layout coordinates of one or more Layout points from the Design Model that are to be Laid Out. Examples of Layout points are important construction points, such as, bolt positions, pipe connections, wall corners, points on a floor, points on a wall, points on a ceiling, or the like. In some embodiments, the Layout coordinates are in a working coordinate system of the Scene Model in which the survey device has been localized. The Layout coordinates are automatically loaded or manually input by the user to the processor or computer system. Next, an operation is performed to calculate the distance and direction from the current location of the Indicator as determined by operation 208, to the Layout coordinates. In some embodiments, the current position of the Indicator is determined based on the location of the survey device and the known or determinable spatial relationship between the sensor and the indicator. For example, if the Layout coordinate is at (10 m, 10 m, 10 m) in XYZ coordinates of a working coordinate system of the scene model, and the location of the Indicator from operation 208 is at (10.4 m, 10.3 m, 10 m) in XYZ coordinates of the same working coordinate system, then the distance would be computed as 0.5 m (i.e., the Cartesian distance between the Layout coordinate and the Indicator coordinate), and the direction would be in the negative X direction and negative Y direction, with a vector of (−0.4 m, −0.3 m, Om), as would be readily understood by one of ordinary skill in the art. After calculating the distance and direction from the Indicator location to the Layout coordinate, the calculated distance and direction are reported so that the user may move the Indicator onto the Layout point. In the example above where the Layout point was 0.5 m away in the negative X and Y directions, the calculated distance and direction would be reported to the user in a way that facilitates his or her moving the Indicator in the right direction to ultimately position the Indicator at the Layout point, where the user may then place a mark on the surface for subsequent construction tasks. In some embodiments, the report may be a directional arrow displayed on a screen along with a distance to move. In some embodiments, the direction and distance displayed to the user may be updated rapidly as the survey device is moved to reflect real-time instructions for how to move the Indicator to the Layout point. The described update of the direction and distance to the Layout point involves repeated performances of operations 203, 204, 206, 208 as described herein. In some embodiments the report may include audible directions and/or other types of instructions to direct the user to move the Indicator to the Layout point. In some embodiments, a visible or audible confirmation is generated when the Indicator reaches the Layout point. The described direction and distance from the Indicator location to the Layout coordinate constitute an example of outputting a spatial relationship between the Indicator location and the Layout coordinate to guide the user to the Layout coordinate. In another example, the spatial relationship between the Indicator location and the Layout coordinate is output by displaying a map of a section of the scene model and indicating the Indicator location and the Layout coordinate on the displayed map.

At operation 213, the scene model received at operation 202 or generated at operation 207 is updated based on the measurement data captured at the current point. For example, at least a part of the measurement data captured at the current point, which represents an element or a feature of the scene not yet included in the scene model, is added to the scene model. For another example, an element or a feature of the scene, which is currently included in the scene model but appears inaccurate in view of the currently captured measurement data, is removed from the scene model, or corrected to be consistent with the measurement data. The updated scene model is used for matching (operation 206), localizing (operation 208) and using (operation 210) the survey device at subsequent points (or positions) at the scene.

When the user has finished using the localized survey device at the current point, the process returns to operation 203, i.e., the user moves the survey device to a subsequent or new point at the scene. The process then proceeds to operation 204 to capture new measurement data at the new point, then to operation 206 to match the new measurement data to the same working coordinate system of the scene model that has been previously mapped at the initial point, then to operation 208 to update the location of the survey device at the new point, then to operation 210 to use the survey device localized at the new point for measurements and/or laying out and/or updating the Scene Model, as described herein. The operations 203, 204, 206, 208, 210 are repeatedly performed at various points at the scene to update the location of the survey device, i.e., to localize the survey device, at those points and use the localized survey device for measurements and/or laying out and/or updating the Scene Model at those points. In some embodiments, while being used at a scene, the survey device is always localized in the same corresponding scene model describing the scene. As a result, accumulated errors as in other approaches are avoidable, in one or more embodiments.

FIG. 3 is a diagram schematically showing a survey device in an operation, in accordance with some embodiments. In the example configuration in FIG. 3, the survey device being used is survey device 120 described with respect to FIG. 1B. Other survey device configurations are within the scopes of various embodiments. For simplicity, FIG. 3 describes in two dimensions (2D) how the survey device 120 locates itself by aligning measurements its data sensor 124 (not shown in FIG. 3) captures from the surrounding Scene with a pre-existing Scene Model to compute the current location and orientation of survey device 120 within the Scene. The operations and/or calculations described with respect to FIG. 3, though illustrated in two dimensions, may easily be adapted to three dimensions (3D) as will be apparent to one of ordinary skill in the art.

As described with respect to operation 202 in FIG. 2, a processor or computer system included in or coupled to survey device 120 receives a pre-existing Scene Model 300. In the example configuration in FIG. 3, Scene Model 300 is a floorplan of a room. The room is the scene where survey device 120 is used for surveying tasks. Other scene model configurations and/or types of scenes are within the scopes of various embodiments. In some embodiments, Scene Model 300 includes coordinates in a working coordinate system 302 (also referred to herein as “coordinate system 302”). In the example configuration in FIG. 3, coordinate system 302 is a Cartesian coordinate system having an X axis, a Y axis, and an origin 303 with coordinates (0,0). Other types of coordinate systems are within the scopes of various embodiments. Coordinate system 302 may be the same as, or different from, a pre-defined coordinate system that describes Scene Model 300 when Scene Model 300 is generated (e.g., at operation 207) or loaded (e.g., at operation 202).

As described with respect to operation 204 in FIG. 2, the processor or computer system further receives measurement data captured by sensor 124 of survey device 120 located at an initial point 304 inside the room (i.e., the scene). Although in FIG. 3, reference numeral 304 schematically points to the top part of survey device 120 where sensor 124 is located, initial point 304 is actually where indicator 128 of survey device 120 is located at in the scene. However, because sensor 124 and indicator 128 have a predetermined or determinable spatial relationship as described with respect to FIG. 1B, the location of indicator 128 can be calculated from the location of sensor 124, and vice versa. Therefore, when the location of one of indicator 128 and sensor 124 is known, the location of the other of indicator 128 and sensor 124 is also known. For simplicity, in the description herein, the location of sensor 124 and the location of indicator 128 can be considered the same.

Before survey device 120 is localized, point 304 originally has an unknown location and unknown orientation (indicated by arrow 306) relative to coordinate system 302 of Scene Model 300. Generally, the orientation is three-dimensional (3D) and is defined by a combination of tilt angle 136 of survey device 120 as described with respect to FIG. 1C, and the direction survey device 120 is facing as represented by arrow 306. In the example configuration in FIG. 3, for simplicity, it is assumed that survey device 120 is in vertical posture 131, and the orientation becomes two dimensional (2D) and is represented by arrow 306. In FIG. 3, the location of point 304 is estimated as (0,0), i.e., the coordinate origin, in a coordinate system X′-Y′ of survey device 120, and the orientation of survey device 120 is estimated as the positive direction of the X′ axis in coordinate system X′-Y′ of survey device 120. Other estimated locations and/or orientations of an initial point are within the scopes of various embodiments. Coordinate system X′-Y′ is an example of a working coordinate system of the measurement data and/or an example of a working coordinate system at point 304. It should be noted that although the location and orientation of survey device 120 at point 304 are originally unknown in coordinate system 302 of Scene Model 300, at least the location of point 304 is already known when point 304 is a control point that has a known location, in at least one embodiment. Sensor 124 of survey device 120 scans the scene, and collects Measurement Data 308.

As described with respect to operation 206 in FIG. 2, the processor or computer system is configured to match, e.g., to align and fit, Measurement Data 308 to Scene Model 300. In other words, a space of Measurement Data 308 is mapped or matched to a space of Scene Model 300. In some embodiments, such mapping or matching is performed using a working coordinate system of Measurement Data 308 and a working coordinate system of Scene Model 300, without being limited to any particular choice or type of the working coordinate systems. Therefore, in at least one embodiment, the working coordinate system, e.g., coordinate system X′-Y′, of Measurement Data 308 may be any coordinate system usable to describe Measurement Data 308, and/or the working coordinate system, e.g., coordinate system 302, of Scene Model 300 may be any coordinate system usable to describe Scene Model 300. Example algorithms for matching Measurement Data 308 to Scene Model 300 include, but are not limited to, “cloud-to-cloud” (C2C) algorithms, “cloud-to-model” (C2M) algorithms, or the like. In some embodiments, this alignment and fitting may be performed using an automated algorithm such as the Iterative Closest Point (ICP) algorithm. An example ICP algorithm is described in “Object Modelling by Registration of Multiple Range Images” by Yang Chen and Gerard Medioni, Proceedings of the 1991 IEEE International Conference on Robotics and Automation, Sacramento, Calif., April 1991, which is incorporated by reference herein in its entirety. In some embodiments, “feature points” (i.e., points in regions of high curvature) may be calculated from the Measurement Data 308 and compared to “feature points” within the Scene Model 300, and a transform 310 may be computed which optimizes the overlap between the two sets of feature points. In some embodiments, transform 310 comprises at least one of a non-linear transform, rotation, translation, shearing or scaling. In some embodiments, a combination of approaches or algorithms may be employed to find the optimal transform 310 to align and fit the Measurement Data 308 to the Scene Model 300. In the specific example described with respect to FIG. 3, transform 310 is a rigid body transform comprising rotation and/or translation. The example configuration in FIG. 3 involves a simplified situation where orientation 306 is 2D and, therefore, transform 310 is also 2D. In some embodiments where the orientation is 3D, transform 310 is a 3D transform.

As described with respect to operation 208 in FIG. 2, the processor or computer system is configured to determine the location and orientation of survey device 120 in coordinate system 302 of Scene Model 300 which has been aligned and fit to Measurement Data 308. For example, FIG. 3 shows survey device 120 is Localized within the Scene by using the same transform 310 that was used to fit the Measurement Data 308 to the Scene Model 300 and applying transform 310 to the initial location and orientation of survey device 120. The localized survey device 120 placed at point 304 is determined to have a location at coordinates (X₁,Y₁) in coordinate system 302 of Scene Model 300. Orientation 306 of working coordinate system X′-Y′ that describes Measurement Data 308 is mapped to orientation 312 in coordinate system 302 of Scene Model 300. Once survey device 120 is Localized, any measurements taken by survey device 120 will themselves be Localized, and any feature points from the Design Model may be Laid Out in the same coordinate system 302. In some embodiments, when point 304 is a control point having a known location, coordinate system 302 associated with point 304 also has a known location and orientation. In some embodiments, coordinate system 302 is unchanged and forms the base map for tracking and localizing survey device 120 throughout the operation of survey device 120 at the scene.

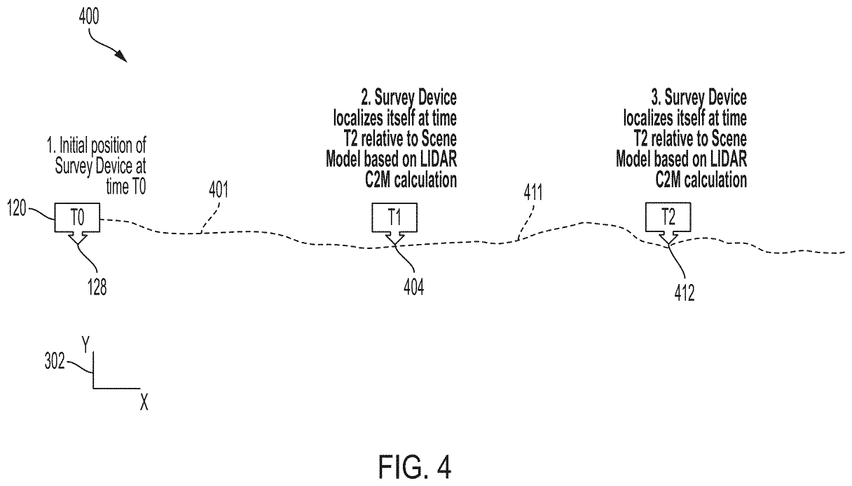

As described with respect to operation 203 in FIG. 2, in some embodiments, when survey device 120 is moved to a new point in the scene, one or more of the operations described above are performed at the new point. For example, a new set of measurement data is captured by sensor 124 at the new point, as described with respect to Measurement Data 308. A new transform is calculated to align and fit the new set of measurement data to Scene Model 300, as described with respect to transform 310. The location and orientation of survey device 120 at the new point are determined based on the new transform, to localize survey device 120 at the new point. This process is repeated at subsequent points as survey device 120 is moved around the scene. An example of this process is described with respect to FIG. 4.

FIG. 4 is a diagram schematically showing a survey device in an operation, in accordance with some embodiments. In the example configuration in FIG. 4, the survey device being used is survey device 120 described with respect to FIG. 1B. Other survey device configurations are within the scopes of various embodiments. In FIG. 4, survey device 120 is schematically illustrated with physical indicator 128 at a tip of support 126 (not shown in FIG. 4) of survey device 120. For simplicity, reference numerals 120, 128 are indicated only at timing TO, and are omitted at other timings T1-T3.

In the example configuration in FIG. 4, sensor 124 (not shown in FIG. 4) of survey device 120 includes a LIDAR scanner. In the example configuration specifically described hereinafter with respect to FIG. 4, the mapping of measurement data captured by the LIDAR scanner to the scene model is referred to as “C2M matching.” However, other mapping or matching techniques/algorithms are within the scopes of various embodiments.

In FIG. 4, at timing TO, survey device 120 is at an initial position indicated by indicator 128. The location of survey device 120 at timing TO is either known (when the initial position is a control point) or determined by a previous LIDAR scan and C2M matching to a scene model, as described with respect to FIGS. 2-3. Survey device 120 is then moved to a next point to be measured or laid out. For example, after moving along a path 401 from the initial position, at timing T1, survey device 120 localizes itself by capturing LIDAR measurement data and performing C2M matching of the captured LIDAR measurement data to the same scene model at timing TO. As a result, survey device 120 determines that its location at timing T1 is location 404. Similarly, after moving along a path 411 away from location 404, at timing T2, survey device 120 localizes itself by capturing LIDAR measurement data and performing C2M matching of the captured LIDAR measurement data to the same scene model at timing TO, and determines that its location at timing T2 is location 412. The described process is further repeated. The specific matching techniques and/or sensor types, such as C2M, LIDAR, described with respect to FIG. 4 are examples. Other matching techniques and/or sensor types are within the scopes of various embodiments. All locations of survey device 120 during the process described with respect to FIG. 4 are in coordinate system 302 of the scene model. However, as described herein, any other working coordinate system is usable instead of coordinate system 302, in one or more embodiments.

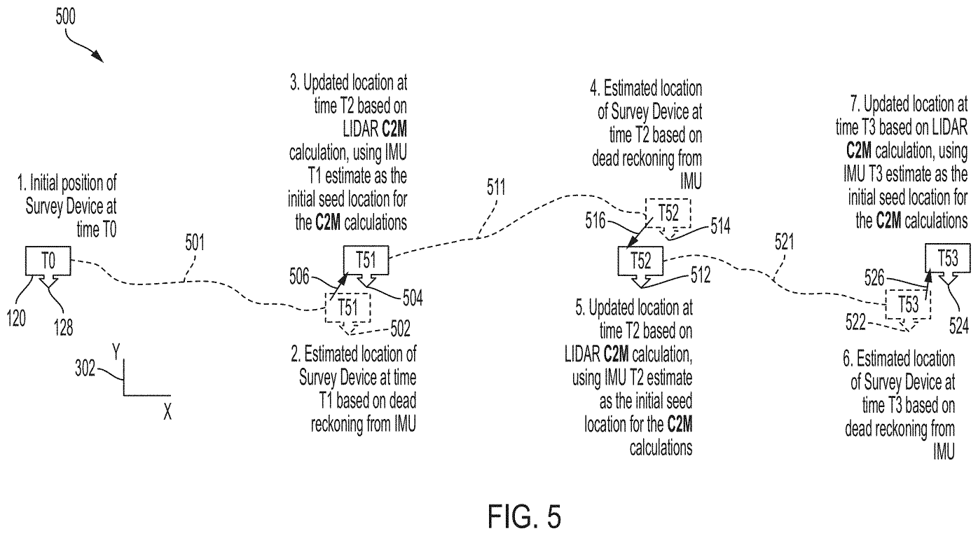

In the example process described with respect to FIG. 4, survey device 120 localizes itself at a first point (e.g., 404) and then at a second point (e.g., 412) along a path (e.g., 411). In some embodiments, while survey device 120 is moving from the first point to the second point, the location and orientation of survey device 120 are tracked by one or more sensors (such as an IMU) of survey device 120. When survey device 120 reaches the second point, the tracked location and/or orientation of survey device 120 are used as an estimate or a seed position to facilitate and/or accelerate the calculation of a transform to be used for localization at the second point. As a result, accuracy and/or speed of the localization process are improved. An example of this process is described with respect to FIG. 5.

FIG. 5 is a diagram schematically showing a survey device in an operation, in accordance with some embodiments. In the example configuration in FIG. 5, the survey device being used is survey device 120 described with respect to FIG. 1B. Other survey device configurations are within the scopes of various embodiments. In FIG. 5, survey device 120 is schematically illustrated with physical indicator 128 at a tip of support 126 (not shown in FIG. 5) of survey device 120. For simplicity, reference numerals 120, 128 are indicated only at timing T50, and are omitted at other timings T51-T53.

In the example configuration in FIG. 5, sensor 124 (not shown in FIG. 5) of survey device 120 includes a LIDAR scanner and at least one IMU device. In some embodiments, estimates by the IMU device and mapping of measurement data captured by the LIDAR scanner to a scene model are used together to localize survey device 120, in such a manner that these techniques complement each other. In the example configuration specifically described hereinafter with respect to FIG. 5, the mapping of measurement data captured by the LIDAR scanner to the scene model is referred to as “C2M matching.” However, other mapping or matching techniques/algorithms are within the scopes of various embodiments.

Specifically, IMU devices are electronic devices that can very accurately measure the forces (or accelerations) that act on an instrument. IMU devices can measure linear accelerations along three axes and rotational accelerations around three principal axes. By accumulating these readings over time, IMU devices can track the location and orientation of an instrument, e.g., survey device 120, by using dead reckoning. In an example configuration, IMU devices output rapid measurements (often up to 1000 measurements/second), allowing virtually instantaneous tracking/positioning at all times. Dead reckoning from these measurements is usually quite accurate over short periods of time. Although IMU devices can be accurate with little instantaneous error, there may be a considerable accumulation of error over time. As a simple example, assuming an IMU device is off by a half an inch every second, then after a minute, the accumulated error (also referred to as “drift”) could be 30 inches, i.e., dead reckoning from the IMU device would indicate a location 30 inches away from the actual location of the instrument.

LIDAR scans are quite accurate when successfully matched to a base map or scene model. For example, when measurement data captured by a LIDAR scanner are successfully matched to an existing base map or scene model, by using, e.g., cloud-to-model (C2M) matching techniques, it is possible to localize the instrument within 1-3 millimeters of the actual location of the instrument. However, if C2M fails to find a match or if C2M finds a false match between the scan data (i.e., measurement data) and the base map, the error may be unacceptably large. Another consideration is that the matching process is slower than IMU dead reckoning, and may take a few seconds to find a match in some situations.

In some embodiments, an IMU device and a LIDAR scanner are used together in a manner to obviate the noted considerations. Specifically, it has been noted that enormous errors caused by incorrect matches of LIDAR measurement data to a base map are often caused by a poor initial estimate (or seed position) of the location of the instrument. When a relatively accurate initial estimate or seed position (e.g., within a meter in at least one embodiment) is available, then the risk of a bad match is almost zero. In some embodiments, dead reckoning provided by the IMU device is used to continuously track the location and orientation of the instrument (i.e., survey device 120), and then the tracked location and orientation of the instrument are periodically updated with a much more accurate reading from the LIDAR scanner. The dead reckoning from the IMU device provides a close initial estimate for the C2M matching calculations, and prevents or greatly reduces the possibility of large errors due to incorrect matches of the LIDAR measurement data to the base map or scene model. The periodic updates by the LIDAR measurement data and C2M matching prevent large accumulations of errors or “drift” from the IMU device.

In the example in FIG. 5, at timing T50, survey device 120 is at an initial position indicated by indicator 128. The location of survey device 120 at timing T50 is either known (when the initial position is a control point) or determined by a previous LIDAR scan and C2M matching to a scene model, as described with respect to FIGS. 2-3. Survey device 120 is then moved to a next point to be measured or laid out. While survey device 120 is being moved, the IMU device rapidly updates the location and orientation of survey device 120 to track the movement of survey device 120. The tracked locations of survey device 120 as reported by dead reckoning of the IMU device are schematically shown by paths 501, 511, 521. A first interval at which the IMU device updates the location and orientation of survey device 120 is short. For example, the IMU device outputs from 100 to 1000 measurements/second, and the first interval at which the IMU device updates the location and orientation of survey device 120 is from 1 to 10 ms. At a second interval ΔT greater than the first interval of updates by the IMU device, measurement data output by the LIDAR scanner are periodically used for a C2M matching with the same base map or scene model at timing T50. For example, the LIDAR scanner completes between 10 and 20 revolutions per second, and a “frame” is created from each complete revolution and the trajectory is updated at the second interval from 50 ms to 100 ms. In the example configuration in FIG. 5, all locations of survey device 120 during the process described with respect to FIG. 5 are in coordinate system 302 of the scene model. As described herein, any other working coordinate system is usable instead of coordinate system 302, in one or more embodiments.

For example, at timing T51=T50+ΔT, a location 502 estimated at timing T51 based on dead reckoning from the IMU device is used as a seed position for C2M matching of the LIDAR measurement data captured at timing T51 to the same scene model at timing T50. As described herein, the dead reckoning from the IMU device provides a sufficiently close seed position for the C2M matching. As a result, a match is found and indicates a more accurate location 504 of survey device 120 at timing T51. Location 502 estimated by the IMU device is updated, as indicated at 506, to be location 504 determined by C2M matching of the LIDAR measurement data to the scene model. Location 504 is subsequently used by the IMU device, instead of location 502, for further tracking of survey device 120.

At timing T52=T51+ΔT, a location 512 estimated at timing T52 based on dead reckoning from the IMU device is used as a seed position for C2M matching of the LIDAR measurement data captured at timing T52 to same the scene model at timing T50. A match is found and indicates a more accurate location 514 of survey device 120 at timing T52. Location 512 estimated by the IMU device is updated, as indicated at 516, to be location 514 determined by C2M matching of the LIDAR measurement data to the scene model. Location 514 is subsequently used by the IMU device, instead of location 512, for further tracking of survey device 120.

At timing T53=T2+ΔT, a location 522 estimated at timing T53 based on dead reckoning from the IMU device is used as a seed position for C2M matching of the LIDAR measurement data captured at timing T53 to the same scene model at timing T50. A match is found and indicates a more accurate location 524 of survey device 120 at timing T53. Location 522 estimated by the IMU device is updated, as indicated at 526, to be location 524 determined by C2M matching of the LIDAR measurement data to the scene model. Location 524 is subsequently used by the IMU device, instead of location 522, for further tracking of survey device 120. The described process is further repeated periodically. The specific matching techniques and/or sensor types, such as C2M, LIDAR, IMU, described with respect to FIG. 5 are examples. Other matching techniques and/or sensor types are within the scopes of various embodiments.

Various embodiments of a survey device and methods of localizing the survey device, especially within a construction site, and using the localized survey device to make measurements and/or laying out and/or updating the Scene Model in a working coordinate system are described. The survey device contains sensors to capture dimensionally accurate measurements of the surrounding environment (e.g., the scene) and compares that data against a scene model of the environment to accurately locate itself for further operations. The localized survey device may be used to both measure points on a construction jobsite as well as Lay Out design points (i.e., mark design points on the ground or other surfaces) so items, such as, bolts, pipes, or the like, can be installed in their proper design locations. In at least one embodiment, the method comprises receiving Measurement Data such as from a laser scanner, matching that data with a Virtual Model of the scene (Scene Model), computing a linear transform required to match the Measurement Data of the Scene to the Scene Model, and using this linear transform to compute the location and orientation of the Self-Locating Device. The method further comprises reporting the 3D location of the Indicator of the survey device. If the system is being used to Lay Out and the Indicator is a physical pointer, the method further comprises calculating the distance and direction from the current location of the Indicator to the Layout point coordinate, and then reporting that distance and direction to enable the user to move the indicator to the correct location. As a result, a self-localizing survey device, a method, and a system using such a survey device to easily and accurately measure points in three dimensions on a construction jobsite are obtained. The Self-Locating Device may be any type of device such as a measuring instrument, a Layout instrument, or the like.

In some embodiments, the Self-Locating Device includes one or more prisms rigidly attached to the support of the device so the device may be localized through other surveying techniques such as locating the device using a total station.

In some embodiments, a Scene Model is created using a scanning or imaging sensor attached to the Self-Locating Device. The Scene Model thus created may be placed within a working coordinate system by using standard surveying techniques, such as setting the Self-Locating Device over a known point or by using a total station to localize the Self-Locating Device as it captures the Measurement Data to create the Scene Model. The Scene Model thusly captured at the beginning of a project may then be used subsequently as the base map or Scene Model against which to localize the Self-Locating Device as the device is moved to different points at the jobsite.

Some embodiments comprise receiving Measurement Data of the surrounding Scene are received from a scanning device rigidly attached to the Self-Locating Device. Some embodiments comprise receiving Measurement Data of the surrounding Scene from an imaging device rigidly attached to the Self-Locating Device. Some embodiments comprise receiving Measurement Data of the surrounding Scene from both a scanning device and an imaging device, both rigidly attached to the Self-Locating Device. Some embodiments receive the Measurement Data through a Data Interface. In some embodiments, the Measurement Data comprise a 360-degree view of everything visible and surrounding the Self-Locating Device. This is achievable, despite a limited field of view (e.g., limited elevation and/or limited azimuth) of the scanning device, by a “swooshing” operation of the Self-Locating Device, in accordance with at least one embodiment. The Measurement Data will be compared to the Scene Model to find a match and locate the Self-Locating Device within the Scene Model.

Some embodiments comprise computing a linear transform required to match the Measurement Data of the Scene to the Scene Model. If the Scene Model accurately represents the Scene, then a match of the Measurement Data to the Scene Model should be able to be found by translating the Measurement Data in one or more of the three Euclidean dimensions, and/or rotating the Measurement Data around one or more of the three orthogonal axes, and/or linearly scaling the Measurement Data homogenously. Some embodiments comprise computing this linear transform in two dimensions (2D). In some embodiments, a non-linear transform is calculated to match the Measurement Data of the Scene to the Scene Model.

Some embodiments comprise computing the location and orientation of the Self-Locating Device. Because the Measurement Data comes from one or more sensors fixed or attached rigidly, or with a known or determinable spatial relationship, to the Self-Locating Device, the location of the Self-Locating Device is known relative to that Measurement Data. Therefore, the same mapping or transform that matches the Measurement Data to the Scene Model may be used to map or transform the location and orientation of the Self-Locating Device itself into the working coordinate system of the Scene Model.

In some embodiments, when the Self-Locating Device is being used to measure, the 3D (or 2D) location of the Indicator of the Self-Locating Device may be reported.

In some embodiments, when the system is being used to Lay Out and the Indicator is a physical pointer, the distance and direction from the current location of the Indicator to the coordinate of a Layout point may be calculated and reported (i.e., displayed or otherwise conveyed to a user/worker). The reported distance and direction enable the user to move the indicator to the location of the Layout point. In this manner, the system may guide a user to place the Indicator in the right location to mark a Layout point. For example, if a design calls for a hole to be drilled in the floor or a wall at a particular coordinate, the system would give directions and guide a user to accurately place the Indicator, e.g., a physical pointer, at that coordinate, where the user might then make a mark on the floor or wall for the hole to be drilled later.

In some embodiments, the Self-Locating Device is usable regardless of whether a control point and/or a scene model exist(s). Specifically, the Self-Locating Device is usable in a first situation when a control point and a scene model exist, a second situation when a control point exists but a scene model does not exist, a third situation when a control point does not exist but a scene model exists, and a fourth situation when a control point and a scene model do not exist. In the first and second situations when a control point exists, the control point may be the initial point at which the Self-Locating Device is first placed when the Self-Locating Device is brought to a scene. A pre-existing scene model corresponding to the scene (in the first situation) or a scene model generated for the scene (in the second situation) is associated with the known location of the control point and also has a corresponding known location. In at least one embodiment, the known location of the control point is an absolute location relative to the Earth's surface, and the pre-existing or generated scene model also has a corresponding absolute location relative to the Earth's surface. In some embodiments, two of more control points of two different known absolute locations are provided at the scene, and the Self-Locating Device sequentially placed at the two of more control points provides a reference frame for determining an absolute orientation of the scene model relative to the Earth's surface. In the third and fourth situations when a control point does not exist, it is still possible to use the Self-Locating Device for localizing, measurements, laying-out, and/or generating/updating a scene model, although the scene model may not have an absolute location and/or an absolute orientation.

In some embodiments, at least one, or some, or all operations of the described methods are implemented as a set of instructions stored in a non-transitory medium for execution by a computer system, hardware, firmware, or a combination thereof. In some embodiments, at least one, or some, or all operations of the described methods are implemented as hard-wired circuitry, e.g., one or more ASICs.

Accurately measuring locations and laying out locations on a construction jobsite are important tasks but often time-consuming and/or error-prone. In some embodiments, a Self-Locating Device that can easily and accurately localize itself and allow workers to more easily make measurements and/or Lay Out construction design locations, which would save both time and money.

In some embodiments, the described processes for localization and subsequent measurement and laying out by using a Self-Locating Device are entirely automated. As a result, the processes are faster than traditional survey-based localization. In one or more embodiments, with a rapid-capture sensor, such as a Velodyne LIDAR system or the like, localization can be performed in real-time.

In at least one embodiment, once the Self-Locating Device has been initially localized, e.g., by a total station, and mapped to a base map, the total station is no longer needed, because the Self-Locating Device can track itself against the base map. In some embodiments, a total station is not at all required even for the initial localization. As a result, various limitations related to other surveying techniques using a total station can be obviated.

For example, after the initial localization, the Self-Locating Device is no longer required to be in the line of sight with the total station which increases flexibility and productivity.

Further, multiple Self-Locating Devices, after being initially localized, can be simultaneously used independently from each other and independently from a total station to survey the same jobsite or scene. This reduces the surveying time and increases productivity. For example, the multiple Self-Locating Devices all share, or are all initially localized in, the same Scene Model corresponding to the jobsite or scene. After the initial localization, the multiple Self-Locating Devices may be used simultaneously and independently from each other to perform measurements, laying-out, and/or updating the Scene Model. In some embodiments, the measurements and/or Scene Model updates generated by the multiple Self-Locating Devices are merged together and/or shared among the multiple Self-Locating Devices, e.g., by a network or cloud server and/or by peer-to-peer connections among the multiple Self-Locating Devices.

In at least one embodiment, it is possible to automatically compensate for tilting of the rod or support of a Self-Locating Device, e.g., by using an automatically measured tilt angle and the known distance between the indicator and the sensor as described with respect to FIG. 1B. As a result, leveling as in other approaches is not required. The automated tilting compensation and/or automated localization processes eliminate the need for highly skilled surveyors. In some embodiments, the Self-Locating Device can be operated as easily as operating a GPS device or GPS function on a smartphone or tablet.

Total stations are known to be difficult to operate indoors, and unstable on uneven surfaces. In contrast, the Self-Locating Device in accordance with some embodiments functions well in all environments, indoors, outdoors, and is capable of making measurements and/or laying out in in places known to be difficult to measure or layout by a total station, such as on a wall or ceiling.

In some embodiments, initial localization is performed by placing the indicator of the Self-Locating Device on a control point of a known absolute location relative to the Earth's surface. In such embodiments, the location of the scene model after the initial localization will have absolute coordinates relative to the Earth's surface. Subsequent locations or measurements of the Self-Locating Device in the working coordinate system of the scene model will also have absolute coordinates relative to the Earth's surface, which provides additional information and/or accuracy.

In at least one embodiment, the Self-Locating Device comprises at least a LIDAR scanner and one or more IMU devices all rigidly attached to a support such as a rod. In a complete-system configuration, the Self-Locating Device further comprises at least one processor and a display all supported on the support. As a result, computations and reports can be performed by the Self-Locating Device itself without requiring an external computer system. In some embodiments, an external computer system, e.g., a portable device such as a smartphone, tablet or laptop, is coupled to the Self-Locating Device to perform some or all of computations and reports. In at least one embodiment, the Self-Locating Device comprises a portable device equipped with one or more sensors configured to capture the required measurement data, and the portable device is removably but rigidly attached to a support, such as a rod, having a physical indicator, such as a tip of the rod. In some embodiments, various components of the Self-Locating Device, such as one or more sensors, a display, one or more prisms are removably attachable to each other and to the support, which increases customizability of the whole system.

It should be noted that this description is not an exclusive list of embodiments and further embodiments are possible. For example, combinations of the embodiments described herein, or portions of the embodiments described herein, may be combined to produce additional embodiments.

The described methods include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

In some embodiments, a system comprises a survey device and at least one processor. The survey device comprises a support and a sensor attached to the support. The sensor is configured to capture measurement data. The at least one processor is coupled to the sensor to receive the measurement data. The at least one processor is configured to obtain a scene model corresponding to an initial set of the measurement data captured by the sensor when the support is located at an initial position, determine a location of the survey device relative to the scene model based on the initial set of the measurement data and the scene model, and update the location of the survey device relative to the scene model, based on subsequent sets of the measurement data captured by the sensor when the support is located at corresponding subsequent positions.

In some embodiments, a method of surveying a scene comprises placing an indicator, which is a part of a support of a survey device, at an initial position, capturing, by a sensor attached to the support, measurement data of the scene, obtaining a scene model corresponding to the measurement data captured when the indicator is at the initial position, and localizing the survey device relative to the scene model as the survey device is moving around the scene.

In some embodiments, a survey device comprises a rod having a physical indicator, and a Light Detection and Ranging (LIDAR) scanner rigidly attached to the rod and having a predetermined spatial relationship with the physical indicator, and at least one of a processor or a data interface. The processor is supported by the rod and coupled to the LIDAR scanner. The data interface is supported by the rod and configured to couple the LIDAR scanner to an external processor. At least one of the processor or the external processor is configured to localize the survey device relative to a scene model corresponding to measurement data captured by the LIDAR scanner.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A system, comprising:
a survey device comprising a support and a sensor attached to the support, the sensor configured to capture measurement data; and
at least one processor coupled to the sensor to receive the measurement data,
wherein
the at least one processor is configured to:
obtain a scene model corresponding to an initial set of the measurement data captured by the sensor when the support is located at an initial position,
determine a location of the survey device relative to the scene model, based on the initial set of the measurement data and the scene model, and
update the location of the survey device relative to the scene model, based on subsequent sets of the measurement data captured by the sensor when the support is located at corresponding subsequent positions.

2. The system of claim 1, wherein
the at least one processor is configured to:
receive the scene model,
compute a transform to match at least one of (i) the initial set or (ii) at least one of the subsequent sets of the measurement data to the scene model, and
apply the transform to compute the location of the survey device corresponding to the at least one of (i) the initial set or (ii) the at least one of the subsequent sets relative to the scene model.

3. The system of claim 2, wherein
the transform comprises at least one of a non-linear transform, translation, rotation, scaling, or shearing.

4. The system of claim 1, wherein
the at least one processor is configured to generate the scene model based on the initial set of the measurement data captured by the sensor when the support is located at the initial position.

5. The system of claim 1, wherein
at least one of (i) the initial position or (ii) at least one of the subsequent positions has a known location.

6. The system of claim 1, wherein
the at least one processor is configured to update the scene model based on the measurement data.

7. The system of claim 1, wherein
the support comprises an indicator configured to be placed at the initial position and the subsequent positions,
the sensor and the indicator have a known or determinable spatial relationship, and
the at least one processor is configured to determine the location of the survey device relative to the scene model, based on the measurement data and the spatial relationship between the sensor and the indicator.

8. The system of claim 7, wherein
the at least one processor is configured to
determine a current position of the indicator based on the location of the survey device and the known or determinable spatial relationship between the sensor and the indicator,
obtain a location of a layout point where a construction work is to be performed, and
determine and output a spatial relationship between the current position of the indicator and the layout point, to direct a worker to the layout point to mark the layout point for the construction work is to be performed later.

9. The system of claim 7, wherein
the support is a rod,
the indicator is at an end portion of the rod, and
the survey device comprises at least one of:
the at least one processor supported by the rod,
a display supported by the rod, and configured to display the location of the survey device relative to the scene model,
a further sensor supported by the rod, and configured to track the location of the survey device by using dead reckoning, or
a prism supported by the rod, and configured to communicate with a total station.

10. The system of claim 7, wherein
the support is a rod,
the indicator is at an end portion of the rod,
the sensor comprises a Light Detection and Ranging (LIDAR) scanner, and
the survey device further comprises an Inertial Measurement Unit (IMU) supported by the rod, coupled to the at least one processor, and configured to track the location of the survey device by using dead reckoning.

11. A method of surveying a scene, the method comprising:
placing an indicator, which is a part of a support of a survey device, at an initial position;
capturing, by a sensor attached to the support, measurement data of the scene;
obtaining a scene model corresponding to the measurement data captured when the indicator is at the initial position; and
localizing the survey device relative to the scene model as the survey device is moving around the scene.

12. The method of claim 11, wherein
in said capturing the measurement data, the measurement data are captured when the support and the sensor are moved while keeping the indicator stationary.

13. The method of claim 11, wherein
the initial position is previously marked in the scene, or
the location of the initial position is determined by further survey equipment interacting with the survey device having the indicator placed at the initial position.

14. The method of claim 11, wherein
said obtaining the scene model comprises
receiving the scene model, and
mapping the measurement data captured when the indicator is at the initial position to the received scene model, and
said localizing comprises determining a location of the survey device relative to the scene model based on the mapping.

15. The method of claim 11, wherein
said obtaining the scene model comprises generating the scene model based on an initial set of the measurement data captured by the sensor when the indicator is located at the initial position.

16. The method of claim 11, further comprising:
obtaining a location of a layout point where a construction work is to be performed; and
determining and displaying a spatial relationship between a current position of the indicator and the layout point, to direct a worker to the layout point to mark the layout point for the construction work is to be performed later.

17. The method of claim 11, wherein
in said capturing the measurement data, the measurement data is generated using at least one of laser scanning, image capturing, or echolocation.

18. The method of claim 11, further comprising:
periodically capturing, at a first interval and by a further sensor attached to the support, information indicating a location of the survey device as the survey device is moving around the scene;
periodically capturing, at a second interval greater than the first interval and by the sensor, the measurement data; and
updating the location of the survey device by matching the measurement data periodically captured by the sensor with the scene model, wherein said matching uses the information periodically captured by the further sensor as an estimate of the location of the survey device.

19. A survey device, comprising:
a rod having a physical indicator; and
a Light Detection and Ranging (LIDAR) scanner rigidly attached to the rod, and having a predetermined spatial relationship with the physical indicator; and
at least one of
a processor supported by the rod and coupled to the LIDAR scanner, or
a data interface supported by the rod, and configured to couple the LIDAR scanner to an external processor,
wherein at least one of the processor or the external processor is configured to localize the survey device relative to a scene model corresponding to measurement data captured by the LIDAR scanner.

20. The survey device of claim 19, further comprising:
an Inertial Measurement Unit (IMU) supported by the rod, and coupled to at least one of the processor or the data interface,
wherein at least one of the processor or the external processor is configured to, as the survey device is moving,
use information captured by the IMU as an estimate of a location of the survey device to perform matching the measurement data captured by the LIDAR scanner with the scene model, and
update the location of the survey device based on said matching.
